(19) United States
(12) Patent Application Publication
(10) Pub. No.: US 2005/0259596 A1
(43) Pub. Date: Nov. 24, 2005

(54) Topology map displaying system

(75) Inventor: Hiroki Sakai, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/135,578

(22) Filed: May 23, 2005

(30) Foreign Application Priority Data
May 24, 2004 (JP) 2004-153882

(51) Int. Cl. H04L 12/28

(52) U.S. Cl. 370/254

(57) ABSTRACT

In a topology map display, a plurality of devices are represented by a plurality of blocks 21 and physical connections between respective devices are represented by connection lines 25 that couples the plurality of blocks, and also the connection line corresponding to the route, the number of chain connections in which reaches a maximum, is displayed in a distinguishable manner (e.g., a thick connection line) from other connection lines. Also, the blocks of respective devices can be displayed in different modes in response to the number of chain connections that can be newly connected to each device.

### BACKGROUND OF THE INVENTION

1. Field of the Invention

The present invention relates to a topology map displaying system for displaying graphically information on a physical connection network among respective devices in the IEEE1394 system, for example, and a topology map analyzing method capable of acquiring easily connection information necessary for the display of this connection network.

2. Description of the Related Art

In the prior art, as shown in FIG. 8, a system for outputting a graphical display of the physical connection network among respective devices (called a topology map) is present in the IEEE1394 system. Also, various technologies to display the information of the devices connected in a network in a lucid way have been proposed (for example, see JP-A-2002-217906 and JP-A-2000-078156).

### SUMMARY OF THE INVENTION

In the IEEE1394 network system, the devices can be connected up to 63 units at a maximum by employing the tree connection. But there is such a limit that the devices can be connected up to 17 units (=16 hops) when they are chain-connected successively.

In recent years, with the digitization of the television broadcast, it is expected that the IEEE1394 interface is built in many AV devices. For this reason, it is also expected that the number of devices that take part in the IEEE1394 network is increased in each home. As a result, in case the number of connected devices is increased, such a situation will be brought about that, even though the tree connection is employed, the number of chain connections contained in such tree connection exceeds the upper limit.

From the above circumstances, in setting up the IEEE1394 network, the user must display the topology map of the network on a topology map displaying device to check the condition that the maximum number of chain connections does not exceeds the upper limit. In this event, according to the topology map displaying device in the prior art, the user must count the number of chain connections in each device one by one while looking at the topology map, to check the maximum number of chain connections. Therefore, there existed the problem that this operation is immensely complicated. In addition, when an enormous number of devices are used, there also existed the problem that it is very difficult for the user to count up the maximum number of chain connections while looking at the topology map.

It is one of objects of the present invention to provide a topology map displaying system capable of checking easily the maximum number of chain connections while looking at a topology map, in a serial bus system such as a network based on the IEEE1394 standard.

It is another object of the present invention to provide a topology map displaying system capable of deciding easily where a new device should be connected and how the number of chain connections in an overall system is affected by such connection, in the situation where the new device must be connected to the network in which the maximum number of chain connections comes close to the upper limit, and a topology map analyzing method capable of causing a computing unit to make an analysis that is required to display such topology map with a lighter load.

According to a first aspect of the invention, there is provided topology map displaying system for displaying graphically information on a physical connection network among a plurality of devices in a network system in which a plurality of devices are connected electrically via an interface based on the IEEE1394 standard, the topology map displaying system including: an information acquiring unit that acquires one hop connection information with respect to every one of the devices, the one hop connection information representing information on the devices to which one of the devices is connected physically without intervention of other devices; a first computing unit that computes physical connection information representing a mutual connection of the devices in the physical connection network based on the one hop connection information; a second computing unit that computes, based on the one hop connection information, chain connection information containing information indicating two devices that provide a maximum number of chain-connected devices among the plurality of devices, information on a number of chain connections between the two devices, and route information on chain connections between the two devices; and a data generating unit that generates display data for graphically displaying the physical connection information computed by the first computing unit and for graphically displaying the chain connection information computed by the second computing unit, wherein the second computing unit computes information on a chain connection route the number of chain connections in which reaches the maximum, wherein the data generating unit generates the display data to display the devices by a plurality of blocks, display physical connections between the devices by connection lines that connect the devices, and display the connection line corresponding to a route, the number of chain connections in which reaches the maximum, in a distinguishable manner distinguishable from other connection lines, and wherein the data generating unit generates the display data to display information that represents directly or indirectly a maximum number of chain connections, the number of chain connections in which reaches the maximum.

According to a second aspect of the invention, there is provided a topology map displaying system for displaying graphically information on a physical connection network among a plurality of devices in a network system in which a plurality of devices are connected electrically, the topology map displaying system including: an information acquiring unit that acquires one hop connection information with respect to every one of the devices, the one hop connection information representing information on the devices to which one of the devices is connected physically without intervention of other devices; a first computing unit that computes physical connection information representing a mutual connection of the devices in the physical connection network based on the one hop connection information; a second computing unit that computes, based on the one hop connection information, chain connection information containing information indicating two devices that provide a maximum number of chain-connected devices among the plurality of devices, information on a number of chain connections between the two devices, and route information on chain connections between the two devices; and a data generating unit that generates display data for graphically displaying the physical connection information computed by the first computing unit and for graphically displaying the chain connection information computed by the second computing unit.

According to a third aspect of the invention, there is provided a topology map analyzing method for analyzing information on a physical connection network among a plurality of devices in a system in which the devices are electrically connected via a serial bus by physically connecting the devices with each other, the method including: a first step of formulating a data table with X-column X-row data cells, where X is a number of devices connected via the serial bus, the data table in which the devices are allocated to each column of the X columns respectively and to each row of the X rows respectively, and in which the data cells to rows and columns of which a same device is allocated are made invalid; a second step of registering, for each of the devices, a data representing a number of hops “1” in the data cells in which the device in a row and the device in a column are connected directly mutually, based on one hop connection information representing information on other devices to which a device concerned is connected directly without intervention of other devices; and a third step of finding out a first data cell in which data is registered from any N-th row, and finding out a second data cell in which data is registered from a column that contains the first data cell, and then registering data representing the number of hops, which is obtained by adding the number of hops registered in the first data cell and the number of hops registered in the second data cell, into the N-th row M-th column data cell where the M-th column is given as the column with which the same device as the row containing the second data cell is correlated, through respective rows and concerned data cells, wherein repeatedly processing the third step for each of the rows and for each of the data cells in the data table to generate the data table in the data cells of which information on the number of hops of the devices are registered.

### BRIEF DESCRIPTION OF THE DRAWINGS

The above objects and advantages of the present invention will become more apparent by describing preferred exemplary embodiments thereof in detail with reference to the accompanying drawings, wherein:

FIG. 1 is a configurative view of an IEEE1394 bus analyzer according to an embodiment of the present invention;

FIG. 2 is an image view showing a first display example of a topology map by the IEEE1394 bus analyzer of the embodiment;

FIGS. 3A and 3B are explanatory views of a part of the topology map in FIG. 2;

FIG. 4 is an image view showing a second display example of a topology map by the IEEE1394 bus analyzer of the embodiment;

FIGS. 5A and 5B are views explaining a flow of a data table generating process executed by a central processing unit in FIG. 1 to analyze the topology map;

FIGS. 6A and 6B are views explaining a flow of the same data table generating process;

FIGS. 7A and 7B are views explaining a flow of the same data table generating process; and

FIG. 8 is an image view showing a display example of a topology map displaying system in the prior art.

### DETAILED DESCRIPTION OF THE PREFERRED EMBODIMENTS

Embodiments of the present invention will be explained with reference to the drawings hereinafter.

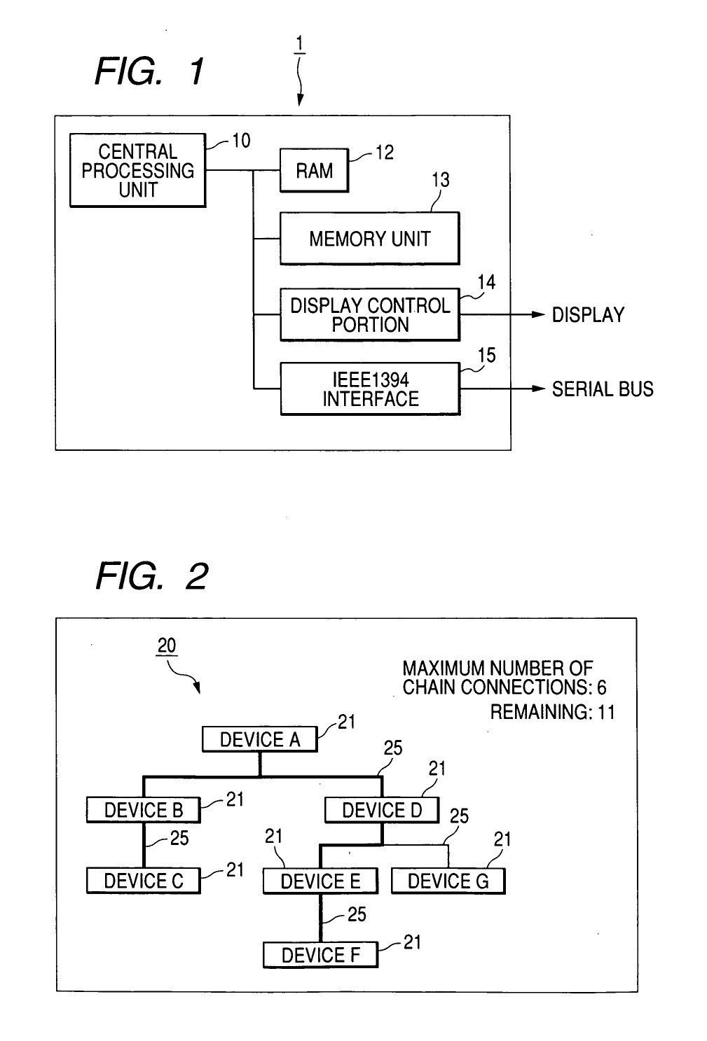

FIG. 1 is a configurative view showing an embodiment of an IEEE1394 bus analyzer as a topology map displaying system of the present invention.

An IEEE1394 bus analyzer 1 of this embodiment includes a central processing unit 10 for executing various processes, a RAM (Random Access Memory) 12 for providing a work space to the central processing unit 10, a memory unit 13 for storing programs that the central processing unit 10 executes, a display control portion 14 for outputting a display signal to a display based on the control of the central processing unit 10, an interface 15 connected to a serial bus based on the IEEE1394 standard to execute the data transmitting/receiving process, and so forth, and displays the topology map of the network system connected to the interface 15 on the display. A first computing unit, a second computing unit, and a data generating unit are constructed by the central processing unit 10 and the programs stored in the memory unit 13 out of them.

In the network system constructed by the IEEE1394 serial bus connection, the identification information (GUID) of respective connected devices and the device information of respective devices containing the model name, and the like can be transferred between respective devices by the data communication via the interface 15 while using the protocol and commands based on the IEEE1394 standard. Also, respective devices can recognize GUID (one hop connection information) of neighboring devices, which are connected physically via the cables, by the data communication via the interface 15. Also, these information can be transferred from respective devices to one device. Also, an information acquiring unit of the bus analyzer 1 is constructed by using these functions. Since these functions are well known as the technology in the IEEE1394 standard and its upper protocol, their details will be omitted herein.

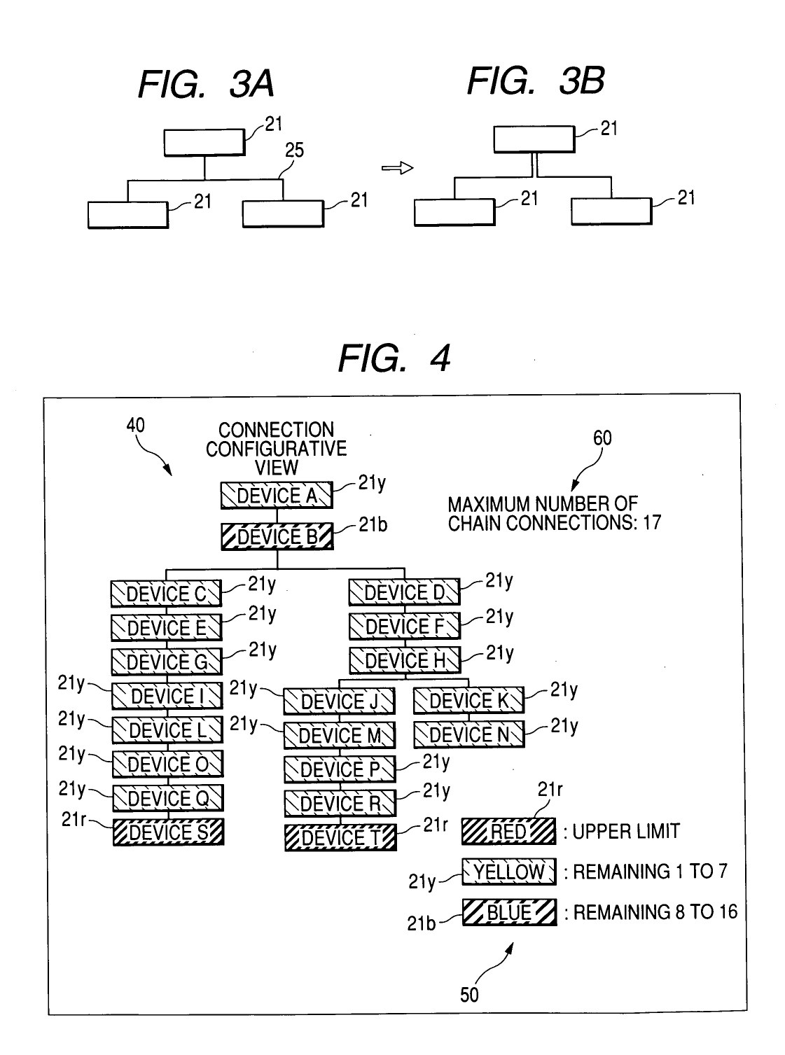

FIG. 2 is an image view showing a first display example of the topology map by the bus analyzer 1. An explanatory view of a part of the topology map is shown in FIG. 3.

The bus analyzer 1 of this embodiment, when receives an operation instruction from the user, can output a display of a topology map 20 shown in FIG. 2.

In this topology map 20, the devices connected to the network are represented by a plurality of blocks 21 to which an identification name, an identification symbol, or the like of the concerned device is affixed respectively, and also physical connections between respective devices are represented by connection lines 25 that couples the blocks 21. The bus analyzer 1 may be any one of the devices shown as blocks 21 in the topology map 20.

In this case, the connection line 25 of the topology map 20, which is branched off in the middle shown in FIG. 3A, actually represents the connection shown in FIG. 3B. Also, the topology map using the blocks 21 and the connection lines 25 can be formed by using various related arts, and explanation of the forming approach will be omitted herein.

Also, in the bus analyzer 1 of this embodiment, the connection route the number of chain connections in which reaches a maximum is displayed by a thick connection line in the topology map 20. In addition, a display “maximum number of chain connections: 6” indicating the maximum number of chain connections and a display “remaining: 11” indicating the remaining number up to which the device can be chain-connected newly to the maximum chain connection are output/displayed on the display respectively. The maximum number of chain connections and the route finding method will be described later.

According to such topology map display, the user can check the connection route, the number of chain connections in which reaches a maximum, and the number of connections in a moment while looking at the topology map 20. Therefore, such topology map display is extremely useful when the user is conscious of the upper limit of the number of chain connections after the number of connected devices is increased.

FIG. 4 is an image view showing a second display example of a topology map by the IEEE1394 bus analyzer of the embodiment.

The bus analyzer 1 of this embodiment, when receives another instruction operation from the user, can further display a topology map 40 shown in FIG. 4.

The topology map 40 displays respective blocks 21 of the devices in a different display mode in response to the allowable number of respective devices, in such a manner that the user can understand how many devices can be chain-connected when a new device is to be connected to individual devices.

More particularly, the devices located on both ends of the chain connection the number of chain connections in which reaches a maximum (the “device S” and the “device T” in FIG. 4) are displayed by the red block 21r. Also, the device to which one to seven units can be chain-connected in the branch connection of the concerned device (the “device A”, the “device C” to the “device R” in FIG. 4) is displayed by the yellow block 21y. Also, the device to which eighth to sixteenth units can be chain-connected in the branch connection of the concerned device (the “device B” in FIG. 4) is displayed by the blue block 21b.

Also, block explaining indications 50 denoting meanings of respective block modes and an indication 60 denoting the maximum number of chain connections are simultaneously displayed.

According to such topology map display, the user can recognize in an instant the situation of the number of chain connections in the overall network and also can decide easily where the new device should be connected and how the number of chain connections in respective locations is affected by such connection. Therefore, such topology map display is extremely useful when the number of devices connected to the network is increased enormously.

Also, as described above, since this topology map displays respective blocks in a different display mode at three stages in response to the remaining number of chain connections, the user can make a rough decision intuitively as follows. That is, the user can decide that the new connection cannot be applied to the red block, the user can decide that the chain connection containing the yellow block in other networks cannot be bridge-connected to the yellow block, and the user can decide that a group of blocks that are blue in other networks can be bridge-connected to the blue block.

In display the above topology maps 20, 40 in FIG. 2 and FIG. 4, first, in the case of FIG. 2, information on the connection route the chain connection in which reaches a maximum in the network connection and the number of chain connections are needed. Then, in the case of FIG. 4, the number of chain connections that reaches a maximum when all devices are assumed as the device located at the end portion (called the individual maximum number of chain connections) are needed. If these information can be acquired, the person skilled in the art can formulate the program that can automatically prepare easily the display in FIG. 2 and FIG. 4.

Next, a topology map analyzing method according to the embodiment of the present invention to acquire these information will be explained hereunder.

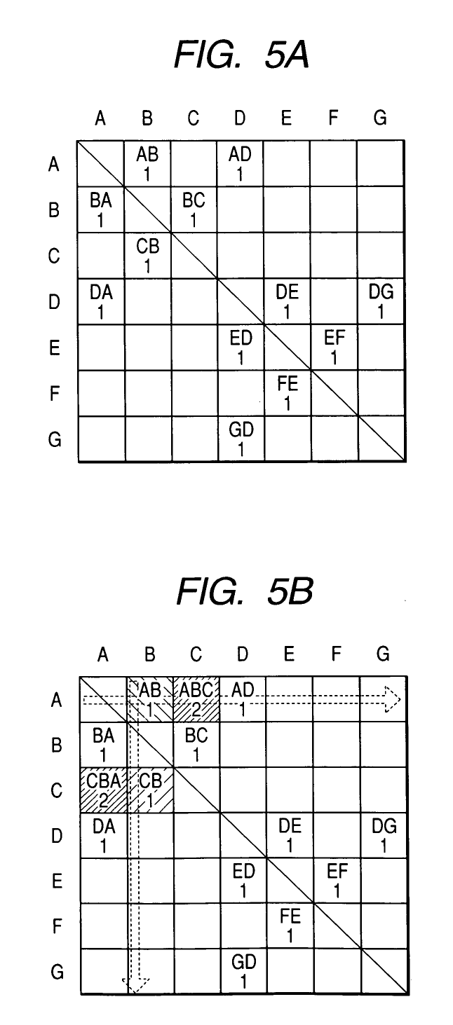

Views explaining a flow of a data table generating process for topology map analysis executed by the central processing unit in FIG. 1 are shown in FIG. 5A to FIG. 7B respectively.

Although described above, respective devices can acquire directly the information of neighboring devices, which are connected physically mutually, by using the commands in the IEEE1394 standard. Also, respective devices can concentrate these information to the bus analyzer 1 of the present embodiment by using the commands in the IEEE1394 standard.

In executing the analysis of the topology map, the bus analyzer 1 executes these processes previously to acquire the information of a set of two devices connected physically (one hop connection information) about all devices in the network.

When the analyzing process of the topology map is started, the central processing unit 10 executes following processes in compliance with the program in the memory unit 13. First, a matrix type data table having rows an columns, which correspond to the number of network-connected devices respectively, is formed on the working area of the RAM 12. Then, all network-connected devices are correlated with respective rows of the data table sequentially, and similarly all network-connected devices are correlated with respective columns of the data table. In addition, the data cell the row and the column of which in the data table are correlated with the same device is defined as the invalid data cell. The data cells are generated here such that their registered data in FIG. 5A are in their empty state.

In FIG. 5A, “A” to “G” denote the “device A” to the “device G” in FIG. 2 respectively. Also, in this data table, one data cell in the X row and the Y column is representsed as the cell XY.

Then, based on the information of a set of two devices connected physically (one hop connection information) that have been acquired previously, the number of hops (=the number of chain connections between the devices containing the devices on both ends−1) “1” and the device connection information (e.g., “AB” if the “device A” and the “device B” are connected) are registered in the data cell that is connected directly to the device in the row and the device in the column. Accordingly, the data table shown in FIG. 5A is generated.

Then, the repeating process is executed as follows based on the data table in FIG. 5A. Thus, the number of hops between the device correlated with the row of the data cell and the device correlated with the column thereof and the device connection information (data indicating the connection devices in their aligned order) are registered sequentially in all data cells of the data table.

The repeating process is executed as follows. Then, explanation will be made with reference to FIG. 5B hereunder. First, one row is observed, and then the data cell in which the data is registered is found this row (step S1). In FIG. 5B, the cell AB in which the data “1” is registered is extracted by observing the A row.

Then, the column of the data cell extracted in step S1 is observed, and then the data cell in which the data is registered is found from this column (step S2). In FIG. 5B, the B column is observed based on the cell AB, and then the cell CB is extracted.

Then, the column Z that corresponds to the row of the cell extracted in step S2 on a one-to-one basis (i.e., the column correlated with the same device as the designated row) is detected, and the data cell in the row observed in step S1 and in this column Z is observed (step S3). In FIG. 5B, the cell AC that is designated by the A row observed in step S1 and in the C column corresponding to the row of the cell CB (C row) on a one-to-one basis is observed.

Then, a value (“2”) obtained by adding the number of hops of the data cell (cell AB) extracted in step S1 and the number of hops of the data cell (cell AC) extracted in step S2 is registered in the data cell observed in step S3 (cell AC) as the number of hops (step S4a).

Similarly, based on the device connection information of the data cell (cell AB) in step S1 (“AB”) and the device connection information of the data cell (cell CB) in step S2 (“CB”), the device connection information (“ABC”) is registered in the data cell (cell AC) observed in step S3 (step S4b). The device connection information registered here can be generated by reversing the order of the device connection information of the data cell in step S2 (“CB”) (i.e., “CB”−>“BC”), then removing the head device from there (i.e., “BC”−>“C”), and then adding the resultant information to the back of the device connection information of the data cell in step S1 (“AB”) (i.e., “AB”−>“ABC”)

After the data is registered in the data cell observed in step S3 (cell AC), similarly the data is registered in the data cell (cell CA) whose row and column are reversed from those of the data cell (cell AC) (step S4c). The registered data gives the data that has the same number of hops and the device connection information whose order is reversed.

Then, the data cells are filled by repeating the processes given in step S1 to step S4c.

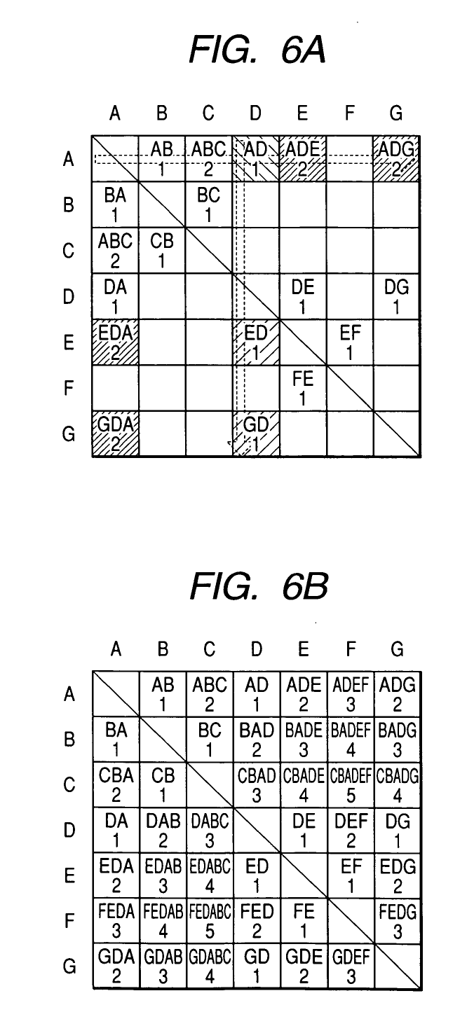

As the sequence in this repeating process, although not interpreted for the limitative purpose, first only the data cell having the number of hops “1” is selected as the data cell extracted in step S2 and then the processes in step S1 to step S4c are applied repeatedly to all rows and columns. For example, in FIG. 6A, the cell AD in which the number of hops “1” is registered is extracted following the process in the A row, and then the cell ED and the cell GD in which the number of hops “1” is registered are extracted by observing the D column as the corresponding column. According to this, the registered data of the cell AE and the cell AG are generated and registered. All the data cells having the number of hops “2” are filled by repeating such processes.

Then, only the data cells having the numbers of hops “1” and “2” are selected as the data cell extracted in step S1 and step S3, and then the processes in step S1 to step S4c are applied repeatedly to all rows and columns. Accordingly, all the data cells having the numbers of hops “3” and “4” are filled.

Then, only the data cells having the numbers of hops “1” to “4” are selected as the data cell extracted in step S1 and step S3, and then the processes in step S1 to step S4c are applied repeatedly to all rows and columns.

All the data cells are filled by executing the repeating processes in step S1 to step S4c in this order. Thus, a data table shown in FIG. 6B is completed.

Meanwhile, in some cases the data have already been registered in the data cell, which is designated in step S3 as the destination cell of the data registration, during these repeating processes. In this case, when the repeating process applied to the data cells extracted in steps S1, S2 having the number of hops that is set to a small value such as “2” or less is to be executed, processes of registering the data in the data cells (steps S4a to S4c) are skipped over and then the process may go to the next data cell processing.

However, when the number of hops of the data cells extracted in steps S1, S3 is set to a large value such as “4”, the following process must be executed. In other words, the number of hops to be registered is calculated, and then the calculated number is compared with the registered number of hops. As a result, the data is not registered and then the process goes to the process of the next data cell if the calculated number of hops is equal to or larger than the registered number of hops, but the registered data are cleared and then newly calculated data are registered once again if the calculated number of hops is smaller than the registered number of hops.

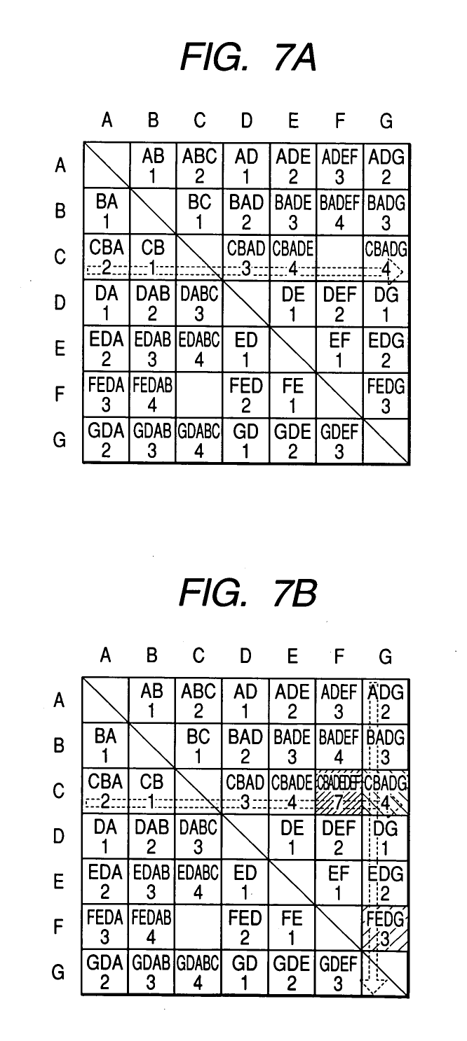

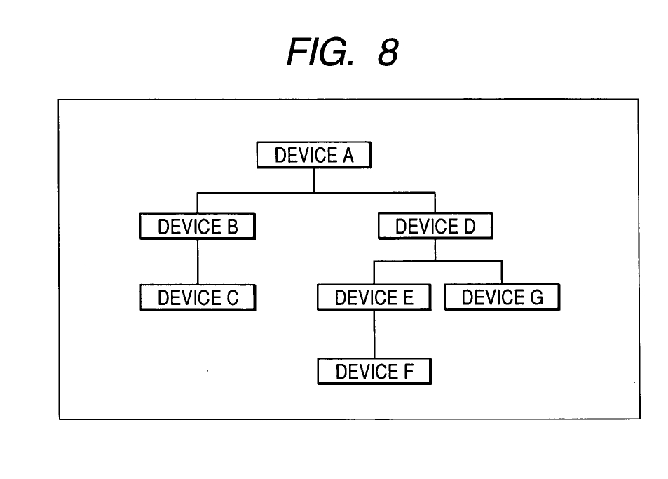

For example, as shown in FIG. 7A, the C row is observed in the state that the data are filled in the data cells having the number of hops of “4” or less. In this case, if the process is started from the A column, no problem is caused. However, for example, if the process is started from the G column, then the cell CG is extracted in step S1, and then the cell FG is extracted subsequently in step S2, the data registered in the cell CF have the number of hops “7” and thus this number of hops becomes larger than the actual value “5”. Therefore, this error can be corrected by executing the overwrite process like the above. For example, in FIG. 7B, the number of hops in the data of the cell CF can be corrected into “5” based on the cell CE and the cell FE extracted by the process in the E column.

As described above, in all the devices connected to the network, the number of hops between respective devices and the device connection information between them can be derived from the data table compiled by using this topology map analyzing method. Also, if the data cell having the maximum number of hops is extracted from this data table, the maximum number of chain connections in the network and its connection route can be checked based on this data cell. In addition, if the maximum value of the number of hops is extracted from each row, the maximum number of chain connections when the device corresponding to the row is regarded as the connection end, i.e., the individual maximum number of chain connections can be checked.

Also, according to the above method, it is feasible to cause the central processing unit 10 to compute such data table in a short time at a lighter load.

The present invention is not limited to the above embodiment and various variations can be applied. For example, in the present embodiment, an example in which the topology map displaying system of the present invention is applied to the IEEE1394 bus analyzer is listed. However, by way of example, this function may be incorporated into various audio-visual apparatuses, or this function may be incorporated into the personal computer.

Also, in order to represent respective devices, names of respective devices may be displayed on the display of the topology map. Also, the individual maximum numbers of chain connections of respective devices are displayed in the topology map shown in FIG. 4 while sorting by three colors, but such individual maximum numbers may be displayed while sorting by four colors or they may be displayed one by one in a different mode, for example.

Also, the order of the processes of generating the data chart in FIG. 5A to FIG. 7B can be changed variously. For example, the process in step S1 to extract the data cells, in which the data has already been registered, from the particular row may be executed to extract such data cells in order of the smaller number of hops. Instead of processing all rows and columns sequentially as the row and the column that are processed in step S1 and step S2, first the data cells in which the data have not been registered yet may be checked in the data table and then the row and the column in which the data cell can be filled with the data may be selectively processed in step S1 and step S2. Also, the data are registered into two data cells whose row and column are replaced with each other when the data are to be registered, but the data may be registered only in one data cell.

As described with reference to the embodiment, there is provided a topology map displaying system for displaying graphically information on a physical connection network among a plurality of devices in a network system in which a plurality of devices are connected electrically, the topology map displaying system including: an information acquiring unit that acquires one hop connection information with respect to every one of the devices, the one hop connection information representing information on the devices to which one of the devices is connected physically without intervention of other devices; a first computing unit that computes physical connection information representing a mutual connection of the devices in the physical connection network based on the one hop connection information; a second computing unit that computes, based on the one hop connection information, chain connection information containing information indicating two devices that provide a maximum number of chain-connected devices among the plurality of devices, information on a number of chain connections between the two devices, and route information on chain connections between the two devices; and a data generating unit that generates display data for graphically displaying the physical connection information computed by the first computing unit and for graphically displaying the chain connection information computed by the second computing unit.

According to the configuration above, the user can acquire simply the information on the number of chain connections while displaying the topology map. Therefore, the user can decide simply whether or not the number of chain connections is coming close to the upper limit and also where the device should be newly connected and how the number of chain connections is affected by such connection.

The devices may be connected via a serial bus based on the IEEE1394 standard. A derivative serial bus connection having the substantially same function as this standard may also be applied similarly.

The topology map displaying system may be configured that the second computing unit computes information on a chain connection route the number of chain connections in which reaches the maximum, and wherein the data generating unit generates the display data to display the devices by a plurality of blocks, display physical connections between the devices by connection lines that connect the devices, and display the connection line corresponding to a route, the number of chain connections in which reaches the maximum, in a distinguishable manner distinguishable from other connection lines.

According to such configuration, the user can decide in a moment which route constitutes the maximum number of chain connections.

The topology map displaying system may be configured that the data generating unit generates the display data to display two devices located on both ends of the route, the number of chain connections in which reaches the maximum, in a distinguishable manner distinguishable from other connections.

According to such configuration, the user can decide in an instant to which device the new device should be connected and how the maximum number of chain connections is affected by such connection.

The topology map displaying system may be configured that the second computing unit computes an individual maximum number of chain connections, in which the number of chain connections out of the chain connections reaches the maximum when each device is regarded as one end, for every one of the devices, and wherein the data generating unit generates the display data to display each of the devices in a manner corresponding to the individual maximum number of chain connections of each of the respective devices.

According to such configuration, the user can decide the influence upon the number of chain connections in all the devices when the new device is connected to respective devices.

The topology map displaying system may be configured that the data generating unit divides the individual maximum number of chain connections into a plurality of sections in order of numbers of each of the individual maximum numbers and correlates different manners with respective sections, and wherein the data generating unit generates the display data to display the each of the devices in a manner (e.g., coloring, different type hatching, or the like) to which the individual maximum number of chain connections of each device belongs.

According to such configuration, the user can recognize simply the situation of the number of chain connections in the overall network and also can decide easily where the new device should be connected and how the number of chain connections in respective locations of the system is affected by such connection.

The topology map displaying system may be configured that the data generating unit generates the display data to display information that represents directly or indirectly a maximum number of chain connections (e.g., the maximum number of the chain connections itself and the remaining number required until the number of chain connections reaches the maximum, etc.), the number of chain connections in which reaches the maximum. According to this, the user can recognize the maximum number of the chain connections in the system without fail.

As described with reference to the embodiment, there is provided a topology map analyzing method for analyzing information on a physical connection network among a plurality of devices in a system in which the devices are electrically connected via a serial bus by physically connecting the devices with each other, the method including: a first step of formulating a data table with X-column X-row data cells, where X is a number of devices connected via the serial bus, the data table in which the devices are allocated to each column of the X columns respectively and to each row of the X rows respectively, and in which the data cells to rows and columns of which a same device is allocated are made invalid; a second step of registering, for each of the devices, a data representing a number of hops “1” in the data cells in which the device in a row and the device in a column are connected directly mutually, based on one hop connection information representing information on other devices to which a device concerned is connected directly without intervention of other devices; and a third step of finding out a first data cell in which data is registered from any N-th row, and finding out a second data cell in which data is registered from a column that contains the first data cell, and then registering data representing the number of hops, which is obtained by adding the number of hops registered in the first data cell and the number of hops registered in the second data cell, into the N-th row M-th column data cell where the M-th column is given as the column with which the same device as the row containing the second data cell is correlated, through respective rows and concerned data cells, wherein repeatedly processing the third step for each of the rows and for each of the data cells in the data table to generate the data table in the data cells of which information on the number of hops of the devices are registered.

According to such method, the maximum number of chain connections of the system and the individual maximum number of chain connections of respective devices can be derived at a lighter load of the computing unit. In other words, the maximum value registered in the data cell of the data table corresponds to the maximum number of chain connections of the system, and the maximum value in the row corresponding to a certain device gives the “individual maximum number of chain connections−1” of the device.

The topology map analyzing method may be configured that, in the third step, device connection information representing the devices, which are chain-connected from the device correlated with the row of the concerned data cell to the device correlated with the column of the concerned data cell, in order of connection are also registered in registering the number of hops in the data cells.

According to such approach, the route corresponding to the number of chain connections registered in respective data cells can be acquired directly from the data table. Therefore, for example, the route giving the maximum number of chain connections can be acquired directly, and others.

As described above, the user can check easily the maximum number of chain connections while looking at the topology map, and also the user can decide easily where the new device should be connected and how the number of chain connections is affected by such connection when the new device must be connected to the network in which the maximum number of chain connections comes close to the upper limit.

Also, it is feasible to cause the computing unit to execute the analysis required to display such topology map at a lighter load.

Although the present invention has been shown and described with reference to the embodiment, various changes and modifications will be apparent to those skilled in the art from the teachings herein. Such changes and modifications as are obvious are deemed to come within the spirit, scope and contemplation of the invention as defined in the appended claims.

1. A topology map displaying system for displaying graphically information on a physical connection network among a plurality of devices in a network system in which a plurality of devices are connected electrically via an interface based on the IEEE1394 standard, the topology map displaying system comprising:
an information acquiring unit that acquires one hop connection information with respect to every one of the devices, the one hop connection information representing information on the devices to which one of the devices is connected physically without intervention of other devices;
a first computing unit that computes physical connection information representing a mutual connection of the devices in the physical connection network based on the one hop connection information;
a second computing unit that computes, based on the one hop connection information, chain connection information containing information indicating two devices that provide a maximum number of chain-connected devices among the plurality of devices, information on a number of chain connections between the two devices, and route information on chain connections between the two devices; and
a data generating unit that generates display data for graphically displaying the physical connection information computed by the first computing unit and for graphically displaying the chain connection information computed by the second computing unit,
wherein the second computing unit computes information on a chain connection route the number of chain connections in which reaches the maximum,
wherein the data generating unit generates the display data to display the devices by a plurality of blocks, display physical connections between the devices by connection lines that connect the devices, and display the connection line corresponding to a route, the number of chain connections in which reaches the maximum, in a distinguishable manner distinguishable from other connection lines, and
wherein the data generating unit generates the display data to display information that represents directly or indirectly a maximum number of chain connections, the number of chain connections in which reaches the maximum.

2. A topology map displaying system for displaying graphically information on a physical connection network among a plurality of devices in a network system in which a plurality of devices are connected electrically, the topology map displaying system comprising:
an information acquiring unit that acquires one hop connection information with respect to every one of the devices, the one hop connection information representing information on the devices to which one of the devices is connected physically without intervention of other devices;
a first computing unit that computes physical connection information representing a mutual connection of the devices in the physical connection network based on the one hop connection information;
a second computing unit that computes, based on the one hop connection information, chain connection information containing information indicating two devices that provide a maximum number of chain-connected devices among the plurality of devices, information on a number of chain connections between the two devices, and route information on chain connections between the two devices; and
a data generating unit that generates display data for graphically displaying the physical connection information computed by the first computing unit and for graphically displaying the chain connection information computed by the second computing unit.

3. The topology map displaying system according to claim 2, wherein the devices are connected via a serial bus based on the IEEE1394 standard.

4. The topology map displaying system according to claim 2, wherein the second computing unit computes information on a chain connection route the number of chain connections in which reaches the maximum, and
wherein the data generating unit generates the display data to display the devices by a plurality of blocks, display physical connections between the devices by connection lines that connect the devices, and display the connection line corresponding to a route, the number of chain connections in which reaches the maximum, in a distinguishable manner distinguishable from other connection lines.

5. The topology map displaying system according to claim 2, wherein the data generating unit generates the display data to display two devices located on both ends of the route, the number of chain connections in which reaches the maximum, in a distinguishable manner distinguishable from other connections.

6. The topology map displaying system according to claim 2, wherein the second computing unit computes an individual maximum number of chain connections, in which the number of chain connections out of the chain connections reaches the maximum when each device is regarded as one end, for every one of the devices, and
wherein the data generating unit generates the display data to display each of the devices in a manner corresponding to the individual maximum number of chain connections of each of the respective devices.

7. The topology map displaying system according to claim 6, wherein the data generating unit divides the individual maximum number of chain connections into a plurality of sections in order of numbers of each of the individual maximum numbers and correlates different manners with respective sections, and
wherein the data generating unit generates the display data to display the each of the devices in a manner to which the individual maximum number of chain connections of each device belongs.

8. The topology map displaying system according to claim 2, wherein the data generating unit generates the display data to display information that represents directly or indirectly a maximum number of chain connections, the number of chain connections in which reaches the maximum.

9. A topology map analyzing method for analyzing information on a physical connection network among a plurality of devices in a system in which the devices are electrically connected via a serial bus by physically connecting the devices with each other, the method comprising:
a first step of formulating a data table with X-column X-row data cells, where X is a number of devices connected via the serial bus, the data table in which the devices are allocated to each column of the X columns respectively and to each row of the X rows respectively, and in which the data cells to rows and columns of which a same device is allocated are made invalid;
a second step of registering, for each of the devices, a data representing a number of hops “1” in the data cells in which the device in a row and the device in a column are connected directly mutually, based on one hop connection information representing information on other devices to which a device concerned is connected directly without intervention of other devices; and
a third step of finding out a first data cell in which data is registered from any N-th row, and finding out a second data cell in which data is registered from a column that contains the first data cell, and then registering data representing the number of hops, which is obtained by adding the number of hops registered in the first data cell and the number of hops registered in the second data cell, into the N-th row M-th column data cell where the M-th column is given as the column with which the same device as the row containing the second data cell is correlated, through respective rows and concerned data cells,
wherein repeatedly processing the third step for each of the rows and for each of the data cells in the data table to generate the data table in the data cells of which information on the number of hops of the devices are registered.

10. The topology map analyzing method according to claim 9, wherein in the third step, device connection information representing the devices, which are chain-connected from the device correlated with the row of the concerned data cell to the device correlated with the column of the concerned data cell, in order of connection are also registered in registering the number of hops in the data cells.
